(19) United States
(12) Patent Application Publication
(10) Pub. No.: US 2013/0027745 A1
(43) Pub. Date: Jan. 31, 2013

(54) IMAGE FORMING APPARATUS, CONTROL METHOD THEREOF AND OPERATIONAL PANEL PRINTED CIRCUIT BOARD ASSEMBLY

(71) Applicant: Soo Young KANG, Seoul (KR)

(72) Inventor: Soo Young KANG, Seoul (KR)

(73) Assignee: SAMSUNG ELECTRONICS CO., LTD., Suwon (KR)

(21) Appl. No.: 13/555,610

(22) Filed: Jul. 23, 2012

(30) Foreign Application Priority Data
Jul. 29, 2011 (KR) 10-2011-0076082

(51) Int. Cl. G06K 15/02

(52) U.S. Cl. 358/1.15

(57) ABSTRACT

An image forming apparatus, a method of controlling the same and an operational panel printed circuit board, in which if a user requests a job before a main control part is completed with booting, additional information about performing the requested job is received in advance while the main control part is being completed with booting, and the additional information received is stored in a job queue such that the additional information is transferred to the MCB part when the MCB part is completed with booting, thereby improving the user experience and the operation speed.

### CROSS-REFERENCE TO RELATED APPLICATIONS

This application claims priority to Korean Patent Application No. 10-2011-0076082, filed on Jul. 29, 2011 in the Korean Intellectual Property Office, the disclosure of which is incorporated herein by reference.

### BACKGROUND

1. Field

Embodiments of the present disclosure relate to an image forming apparatus, a control method thereof and an operational panel printed circuit board assembly, and more particularly, to an image forming apparatus, a control method thereof and an operational panel printed circuit board assembly, in which an operational panel equipment (OPE) part for an interface with a user is booted before a main control board part configured to control the operation of an image forming apparatus.

2. Description of the Related Art

An image forming apparatus is mainly divided into an operation panel equipment (OPE) part, which is configured to receive an input by a user, and a main control board (MCB) part, which is configured to perform a job—such as copying, scanning, and printing. The OPE part receives an input from a user to request a job from the MCB part. In addition, the OPE part receives and shows a result of the job.

The OPE part and the MCB part are implemented using a single CPU and a single board. However, in order to improve the operation speed and a User eXperience (UX), each of the OPE part and the MCB part is implemented using a signal CUP and a single board.

Such a separate configuration between the OPE part and the MCB part bring into a difference of speed in booting the OPE part and the MCB part.

Since a user has a desire to input information almost at the same time of turning on an image forming apparatus, the OPE part is configured to be completed with booting, even before the MCB part is not completed with booting.

When a user establishes several settings on a screen of the OPE part and requests a job, and if the MCB part is in an unavailable state for the requested job, the OPE part notifies a user that the MCB part is in an unavailable state for the requested job by displaying a message “Waiting . . . ” or “Initializing . . . ” In this case, the user needs to keep waiting until the MCB part is in an available state for the requested job, however, resulting in failure to take advantage of the OPE part being booted before the MCB part.

When a security job is requested by a user, even if a MCB part. has been completed with booting, it is not that the requested job is instantly processed since an additional authentication stage of inputting log-in information needs to be performed.

In this case, in order to input log-in information after a user requests a job, the user needs to wait until the MCB part is completed with booting. Since the user inputs the log-in information after waiting until the MCB part is completed with booting, the waiting time increases the operation time required for performing a job and lowers the operation speed of the image forming apparatus.

### SUMMARY

Therefore, it is an aspect of the present disclosure to provide an image forming apparatus, a control method thereof, and an operational panel printed circuit board assembly, in which, if a user requests a job before a main control board part is completed with booting, additional information about performing the requested job is received in advance and is stored in a job queue such that the additional information is transferred to the MCB part when the MCB part is completed with booting.

Additional aspects of the disclosure will be set forth in part in the description which follows and, in part, will be obvious from the description, or may be learned by practice of the invention.

In accordance with one aspect of the present disclosure, an image forming apparatus having a main board configured to control an operation of the image forming apparatus includes an input unit, a display unit, a storage unit, an interface unit and a control unit. The input unit is configured to receive job information for requesting a job from a user. The display unit is configured to display a screen which is used to receive additional information, which is related to perform the job requested by the user. The storage unit is configured to store the job information and the additional information. The interface unit is configured to communicate with the main board. The control unit is configured to determine whether the main board is being booted if a job is requested by a user, to control the display unit to display a screen, which is used to receive additional information related to performing the requested job in advance, if the main board is being booted, to store the job information and the additional information, which are received from the user as the screen is displayed, in the storage unit, and to transfer the job information and the additional information stored in the store unit to the main board if the main board is completed with booting.

The additional information comprises log-in information.

The additional information includes email information which is used to receive a notice after the requested job is completed with processing.

The control unit stores a plurality pieces of job information in the storage unit, and if a plurality of devices connected to the main board are sequentially completed with booting, transfers the plurality of job information in a transfer order that varies with an order that the plurality of devices are completed with booting.

The control unit generates the screen such that the screen has a priority order setting block used to receive a priority order for the job requested by the user.

The control unit generates the screen such that the screen has a device status block representing a real time booting progress of each device connected to the main board.

In accordance with another aspect, a method of controlling an image forming apparatus having a main board configured to control an operation of the image forming apparatus. It is determined whether the main board is being booted if a job is requested by a user. A screen, which is used to receive additional information related to performing the requested job in advance, is displayed if the main board is being booted. Job information for requesting the job and the additional information, which are received from the user as the screen is displayed, are stored in a job queue. The job information and the additional information stored in the job queue are transferred to the main board if the main board is completed with booting.

In the displaying of the screen, the additional information includes log-in information.

In the displaying of the screen, the additional information includes email information used to receive a notice after the requested job is completed with processing.

In the displaying of the screen, the screen includes a priority order setting block used to receive a priority order for the requested job.

In the displaying of the screen, the screen includes a device status block representing a real time booting progress of each device connected to the main board.

In accordance with another aspect, an operational panel printed circuit board assembly communicating with a main board that is configured to control an operation of an image forming apparatus. The operational panel printed circuit board assembly comprises an input unit, a display unit, a storage unit, an interface unit and a control unit. An input unit is configured to receive job information for requesting a job from a user, the job requested by the user. The display unit is configured to display a screen used to receive log-in information from the user in advance. The storage unit is configured to store the job information and the log-in information. The interface unit is configured to communicate with the main board. The control unit is configured to determine whether the main board is being booted if a job is requested by a user, to control the display unit to display a screen, which is used to receive log-in information from the user in advance, if the main board is being booted, to store the job information and the log-in information, which are received from the user as the screen is displayed, in the storage unit, and to transfer the job information and the log-in information stored in the store unit to the main board if the main board is completed with booting.

The control unit generates the screen such that the screen has a priority order setting block used to receive a priority order for the requested job.

The control unit generates the screen such that the screen has a device status block representing a real time booting progress of each device connected to the main board.

As described above, if a user requests a job before a main control part is completed with booting, additional information about performing the requested job is received in advance while the main control part is being completed with booting, and the additional information received is stored in a job queue such that the additional information is transferred to the MCB part when the MCB part is completed with booting, thereby improving the user experience and the operation speed compared to a conventional technology in which additional information about performing a requested job is received only after a MCB part is completed with booting.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an image forming apparatus according to an embodiment of the present disclosure.

FIG. 2 is a view illustrating a relationship between an operational panel equipment (OPE) part and a main control board (MCB) part of an image forming apparatus according to an embodiment of the present disclosure.

FIG. 3 is a block diagram illustrating a relationship among an OPE printed circuit board assembly (PBA) forming the OPE part of FIG. 2, a MCB printed board circuit assembly (PBA) forming the MCB part of FIG. 2 and other boards of FIG. 2.

FIG. 4 is a block diagram illustrating an OPE PBA of an image forming apparatus according to an embodiment of the present disclosure.

FIG. 5 is a schematic view illustrating a platform of an OPE part of an image forming apparatus according to an embodiment of the present disclosure.

FIG. 6 is a detailed view illustrating an application, a framework, a library, and an operating system shown in FIG. 5.

FIG. 7 is a view used to explain a process in which a job queue manager of an OPE part checks a status of each device of a MCB part in an image forming apparatus according to an embodiment of the present disclosure.

FIG. 8 is a detailed view illustrating a job queue manager of a framework of an OPE part in an image forming apparatus according to an embodiment of the present disclosure.

FIG. 9 is a view illustrating a screen that is generated by a job information page generator of a job queue manager of an OPE part in an image forming apparatus according to an embodiment of the present disclosure.

FIG. 10 is a view used to explain an operation of a priority order manager of a job queue manager of an OPE part that primarily performs a job, which is available in a MCB part, among a plurality of jobs stored in a job queue in an image forming apparatus according to an embodiment of the present disclosure.

FIG. 11 is a view used to explain an operation of receiving a priority order of a job from a user through the screen shown in FIG. 9.

FIG. 12 is a view illustrating a booting progress of each device on a screen that is generated by a job information page generator of an OPE part in an image forming apparatus according to an embodiment of the present disclosure.

FIG. 13 is a flow chart illustrating a control method of an OPE part of an image forming apparatus according to an embodiment of the present disclosure.

FIG. 14 is a flow chart used to explain an operation of an OPE PBA of an image forming apparatus according to an embodiment of the present disclosure, the OPE PBA receiving log-in information as additional information in advance while a main PBA is being booted.

### DETAILED DESCRIPTION

Reference will now be made in detail to the embodiments of the present disclosure, examples of which are illustrated in the accompanying drawings, wherein like reference numerals refer to like elements throughout.

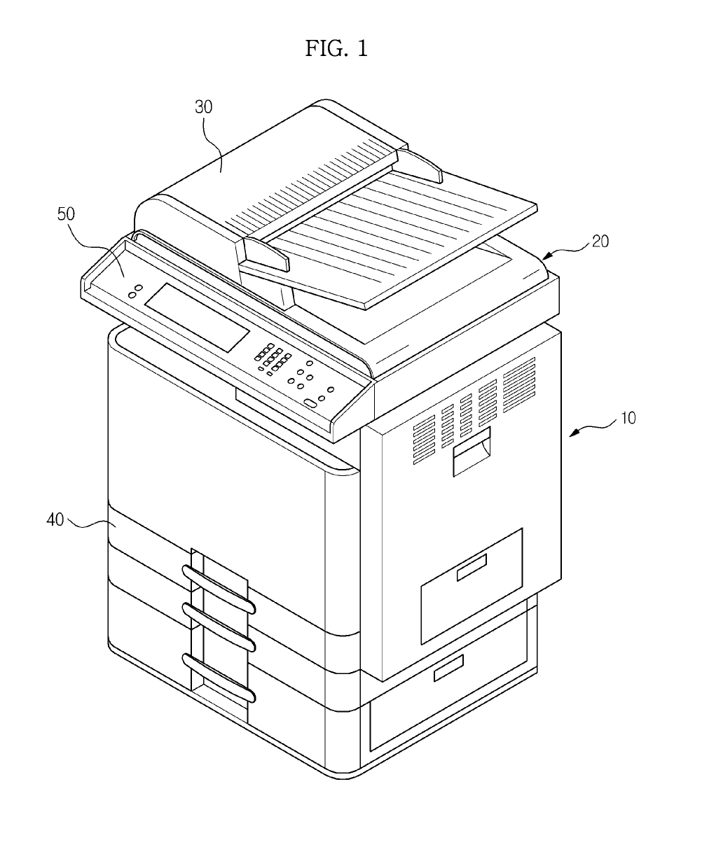

FIG. 1 is a perspective view illustrating an image forming apparatus according to an embodiment of the present disclosure.

As shown in FIG. 1, an image forming apparatus includes a body 10, a scanner 20, an automatic document feeder (ADF) 30, a paper feeding cassette 40, and an operational panel 50.

Various components for image forming, for example, a feeding unit, a laser scanning unit, a development unit, a transfer unit, a fuser unit, a deliver unit, and a sensor unit (not shown)—are installed in the image forming apparatus.

The scanner 20 is disposed at an upper part of the body 10 to scan documents. The scanner 20 performs copying or scanning on documents according to a copy command or a scan command.

The ADF 30 automatically feeds stacked documents one by one.

The paper feeding cassette 40 is disposed at a lower part of the body 10 to accommodate sheets of paper.

The operational panel 50 serves as an interface with a user. The operational panel 50 displays a screen to enable a user to select a desired job and input a command, and receives a job command from a user, such as a print command, a copy command, a scan command, etc.

A user interface screen is displayed on the operational panel 50. The operational panel 50 has a touch panel function that allows a button formed on the user interface screen to be manipulated by fingers of a user. A user selects a desired job by operating buttons that are displayed on the user interface screen while having respective functions, such as a print function, a copy function, or a scan function.

As a user inputs a copy command, a scan command, or a print command through the operational panel 50, a document placed on a plate of the scanner 20 is subject to copying or scanning; or a paper accommodated in the paper feeding cassette 40 is subject to printing with a print data.

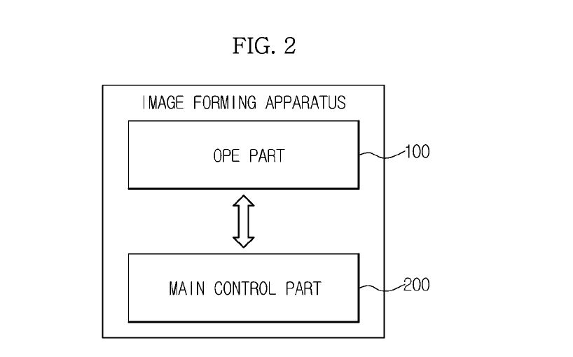

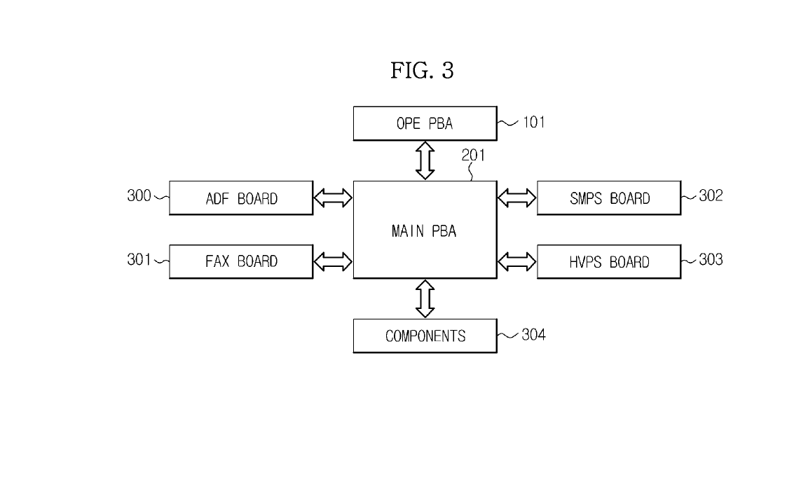

FIG. 2 is a view illustrating a relationship between an operational panel equipment (OPE) part and a main control board (MCB) part of an image forming apparatus according to an embodiment of the present disclosure. FIG. 3 is a block diagram illustrating a relationship among an OPE printed circuit board assembly (PBA) forming the OPE part of FIG. 2, a MCB printed board circuit assembly (PBA) forming the MCB part of FIG. 2 and other boards of FIG. 2.

Referring to FIG. 2, an image forming apparatus includes an operation panel equipment (OPE) part 100 and a main control board (MCB) part 200.

The OPE part 100 displays a screen, through which a job is selected by a user, and receives a job command about the job selected by the user.

The MCB part 200 controls the operation of the image forming apparatus, while performing copying, scanning and printing.

The OPE part 100 is configured to be booted before the MCB part 200 such that a user inputs information just after the image forming apparatus is turned on.

Each of the OPE part 100 and the MCB part 200 is implemented using a Printed Circuit Board Assembly (PBA) which includes a single central processing unit (CPU) and a single board.

Referring to FIG. 3, the OPE part 100 includes an operational panel equipment printed circuit board assembly 101 (hereinafter, referred to as an OPE PBA), and the MCB part 200 includes a main printed circuit board assembly 201 (hereinafter, referred to as a main PBA).

The OPE PBA 101 is communicably connected to the main PBA 201.

The main PBA 201, which is communicably connected to the OPE PBA 101, is connected to an ADF board 300, a fax board 301, a Switching Mode Power Supply (SMPS) 302, a High Voltage Power Supply (HVPS) board 303, and to various components 304 including various types of motors, sensors, and fans.

The ADF board 300 automatically provides documents during a copy or scan operation.

The fax board 301 is a board used to communicate with other multi function equipment or fax apparatus.

The SMPS board 302 supplies the main PBA 201 and other boards with powers of +5V and +24V from an input power source of 110V/220V.

The HVPS board 303 supplies a high voltage to various apparatuses requiring a high voltage in the image forming apparatus, for example, a photoconductor, a charger unit, a development unit, a transfer unit, etc.

The main PBA 201 checks the status of each of the boards 300, 301, 302, 303, and the components 304, which are connected to the main PBA 201, other than the OPE PBA 101. As each of the boards 300, 301, 302, 303, and the components 304 are prepared for operation, the main PBA 201 completes with booting.

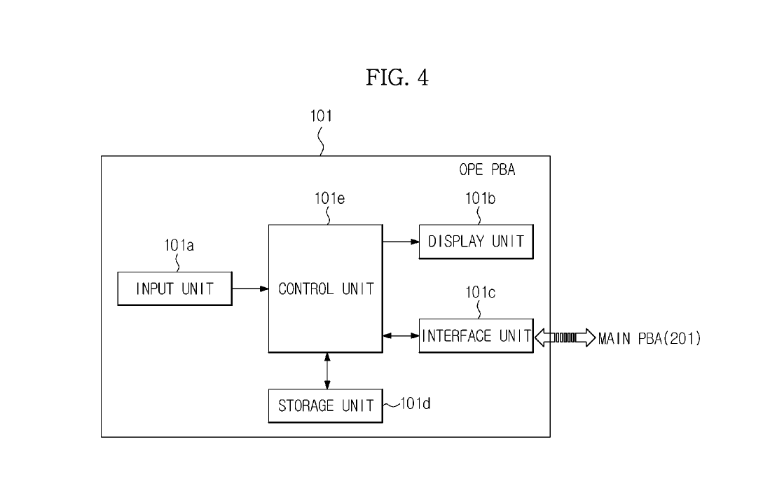

FIG. 4 is a block diagram illustrating an OPE PBA of an image forming apparatus according to an embodiment of the present disclosure.

Referring to FIG. 4, the OPE PBA 101 includes an input unit 101a, a display unit 101b, an interface unit 101c, a storage unit 101d, and a control unit 101e.

The input unit 101a receives various types of information used to perform a job from a user.

The display unit 101b displays a screen used to receive a job command from a user and displays a screen used to receive additional information, for example, log-in information, which is related to perform a job input by a user.

The interface unit 101c the OPE PBA 101 communicates with the main PBA 201 by exchanging information with the main PBA 201.

The storage unit 101d stores job information on a job and additional information related to performing the job, which are input by a user as each screen is displayed, in a job queue.

The control unit 101e displays a home screen on the display unit 101b, which corresponds to an initial screen represented when the OPE PBA 101 is booted as the image forming apparatus is turned on. If a job desired by a user is received through the input unit 101a in a manner that the user selects a desired job on the displayed home screen, the control unit 101e determines whether the main PBA 201 is in an available state to perform a corresponding job, that is, whether the main PBA 201 is completed with booting, by communicating with the main PBA 201 through the interface unit 101c. When the main PBA 201 is being booted, the control unit 101e determines whether additional information related to performing the job input through the input unit 101a exists. If the additional information exists, the control unit 101e displays the screen used to receive the additional information on the display unit 101b. If a user inputs the additional information according to the displaying of the screen used to receive the additional information, the additional information is stored in a job queue. After the main PBA 201 is completed with booting and is available for performing the job, the control unit 101e automatically sends the main PBA 201 the job information and the additional information related to performing the job such that the main PBA 201 performs the corresponding job.

In executing a secured print job requiring additional log-in information, a user selects a secured copy job on a home screen if the image forming apparatus is turned, the control unit 101e determines whether the main PBA 201 is being booted or completed with booting, that is, it is determined whether the main PBA 201 is prepared for perform the copy job. If a result of the determination is that the main PBA 201 is still being booted and is unavailable for the copy job, the control unit 101e displays a screen, which is used to receive log-in information on the display unit 101b, such that log-in information is received from a user in advance while the main PBA 201 is being booted. The log-in information input is stored in the storage unit 101d.

Thereafter, as the main PBA 201 is completed with booting, the control unit 101e sends the main PBA 201 the log-in information and job information about a secured copying, that job information corresponding to a job command which is selected by the user. The main PBA 201 performs a user authentication by checking the log-in information, and performs a copy job corresponding to the job command if the user authentication is succeeded.

As described above, the OPE part 100 controls the screen displayed to a user, and the MCB part 200 controls the operation of the image forming apparatus.

Hereinafter, a platform of the OPE part 100 will be described.

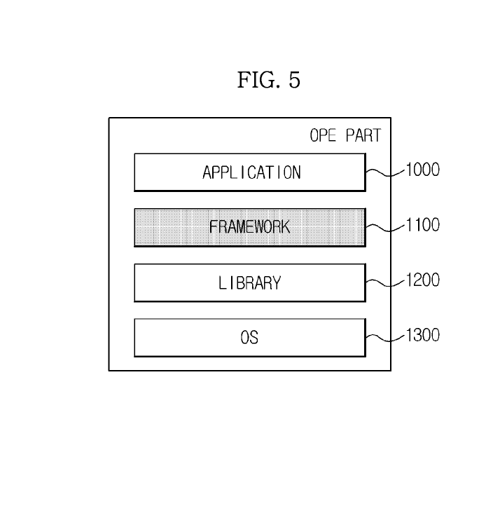

FIG. 5 is a schematic view illustrating a platform of an OPE part of an image forming apparatus according to an embodiment of the present disclosure.

Referring to FIG. 5, a platform of the OPE part 100 is divided into an application 1000, a framework 1100, a library 1200, and an operating system (OS) 1300.

The application 1000 represents an application program used in the image forming apparatus.

The framework 1100 manages applications of the application 1000 and controls a communication with the MCB part 200.

The library 1200 includes a font library, a graphic library, and database that are used by the applications.

The OS 1300 represents an operating system of the OPE part 100. The OS 1300 controls hardware and software, and manages a CPU and input/output apparatuses of the OPE part 100.

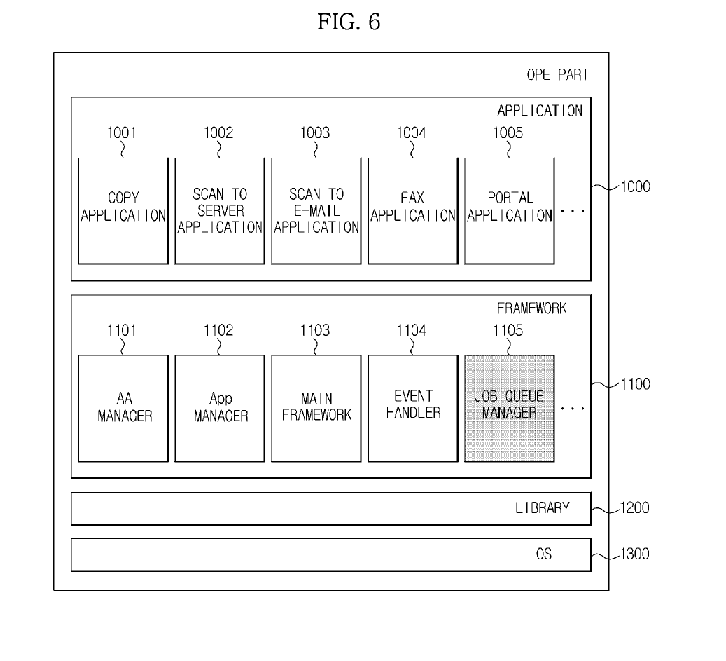

FIG. 6 is a detailed view illustrating an application, a framework, a library, and an operating system shown in FIG. 5.

Referring to FIG. 6, the application 1000 includes various types of applications that are generally used in the image forming apparatus. A copy application represents an application for copying a document, a scan-to-server application represents an application for scanning a document and storing a result in a server and a scan-to-email application represents an application for scanning and emailing a document and a fax application represents an application for a fax job. In addition, a portal application provides a shortcut icon which allows entry to each application as a home screen.

The framework 1100 supports the applications such that the applications do not have a problem in communicating with the MCB part 200.

The framework 1100 includes an Authentication & Authorization manager 1101 (hereinafter referred to as an AA manager), an application manager 1102 (hereinafter referred to as an APP manager), a main framework 1103, an event handler 1104, a job queue manager 1105, etc.

The AA manager 1101 manages authentication and security related jobs. The AA manager 1101 serves to display a log-in screen or an authentication requesting screen to a user.

The App manager 1102 performs a management, such as detecting a currently available application. If applications are stored in the OPE part 100, there is a need to detect which application is stored and available for use in the MCB part 200 and the OPE part 100. In this case, the App manager 1102 performs a management of detecting which application is stored and available for use in the MCB part 200 and the OPE part 100.

The main framework 1103 manages the AA manager 1101, the App manager 1102, the event handler 1104 and the job queue manager 1105.

The event handler 1104 manages an event transferred from the MCB part 200. The event includes status information on various devices connected to the main PBA 201, for example, a device related to a print job, a device related to a scan and a copy job, a device related to a fax job, job progress information, LED status information, etc. The event handler 1104 manages an event that is generated where there is a need to give a user a notice or a request is made by a user.

The job queue manager 1105 primarily queues a job that is generated from the OPE part 100.

Hereinafter, the job queue manager 1105 will be described in detail.

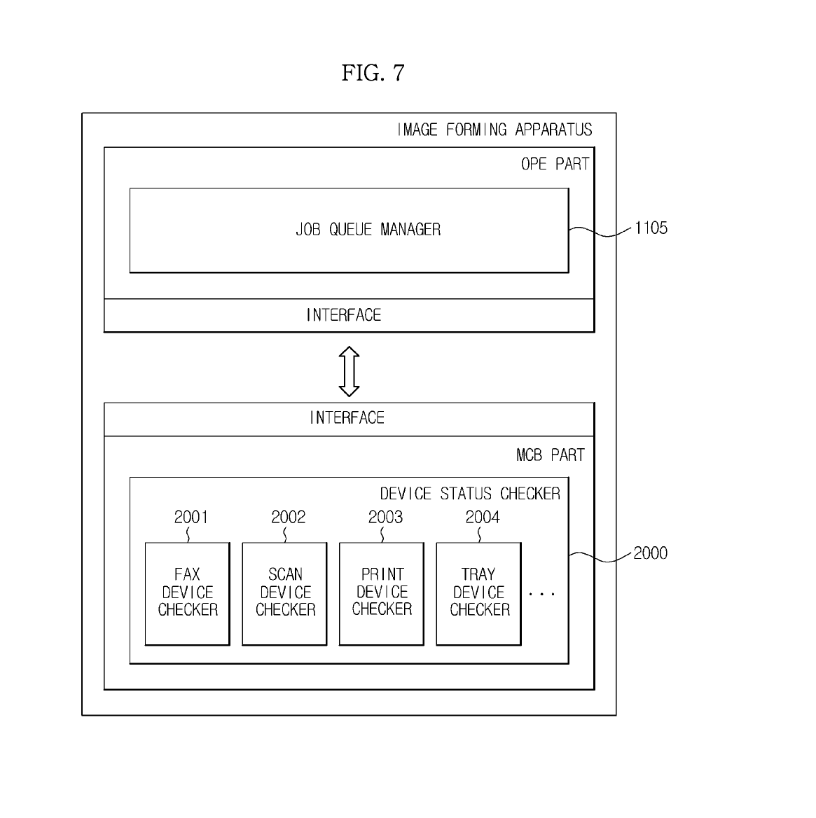

FIG. 7 is a view used to explain a process in which a job queue manager of an OPE part checks a status of each device of a MCB part in an image forming apparatus according to an embodiment of the present disclosure.

Referring to FIG. 7, the OPE part 100 is connected to the main control part 200 as to communication.

As described above, the OPE part 100 allows the job queue manager 1105 to check the status of each device connected to the MCB part 200, and prepares to display a job information page corresponding to a predetermined screen that is suitable for displaying the status of the checked each device.

To this end, the MCB part 200 needs to know the status of each module (device). The MCB part 200 includes a device status checker 2000.

The device status checker 2000 includes a fax device checker 2001, a scanner device checker 2002, a print device checker 2003, and a tray device checker 2004.

The device status 2000 having the above configuration checks status information on each device, such as a fax, a scanner, a printer, a tray, etc., and transfers the checked status information to the OPE part 100.

The OPE part 100 receives the status information and allows the job queue manager 1105 to analyze the status information to determine which job is to be given a priority among the jobs stored in the job queue, and how resources are to be put in practice.

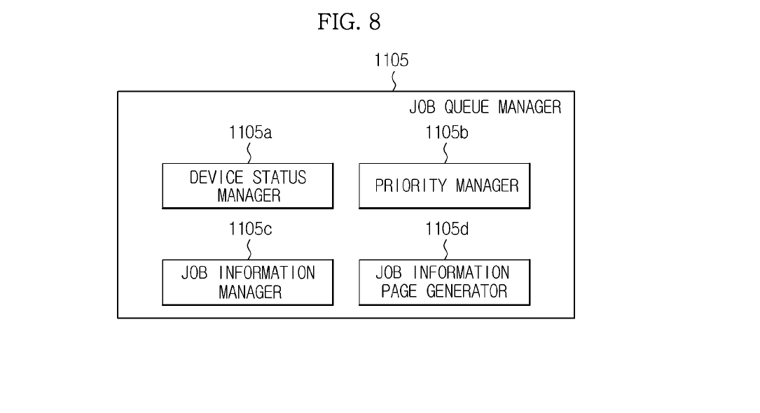

FIG. 8 is a detailed view illustrating a job queue manager of a framework of an OPE part in an image forming apparatus according to an embodiment of the present disclosure.

Referring to FIG. 8, the job queue manager 1105 includes a device status manager 1105a, a priority manager 1105b, a job information manager 1105c, and a job information page generator 1105d.

The device status manager 1105a checks the status of the MCB part 200. The device status manger 1105a checks which device is currently available for use in the main PBA 201. For example, in stages, it is checked which of a print job, a scanner job, and a fax job is available for use. If a print job is not available for use but a scanner job is available for use, a scan to XXX job is determined to be processed. The job information page generator 1105d generates a screen that is displayed to a user. In order for a user to perform a job which requires a log-in, the user performs several settings on the job and presses a job start button. If the MCB part 200 is not available for performing a job since the MCB part 200 is not completed with booting, a log-in window which is used to receive log-in information needs to be displayed. In this case, the job information page generator 1105d provides the screen which is used for log-in information.

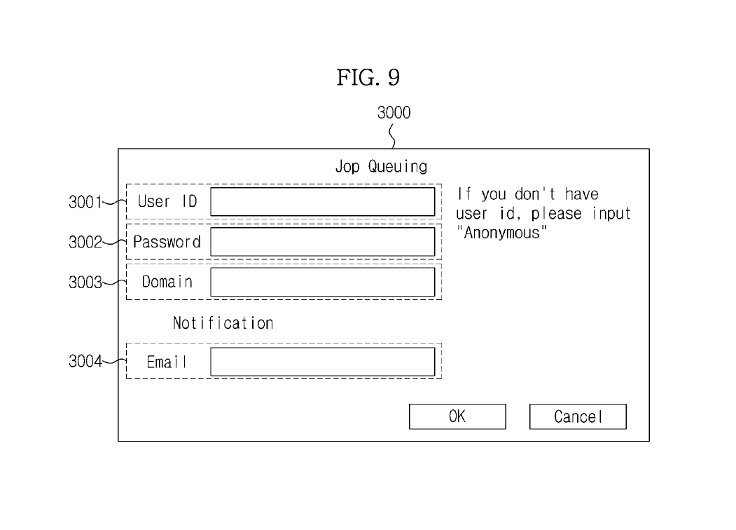

FIG. 9 is a view illustrating a screen that is generated by a job information page generator of a job queue manager of an OPE part in an image forming apparatus according to an embodiment of the present disclosure.

Referring to FIG. 9, a screen 3000, which represents a predetermined page for a job information generated by the job information generator 1105d, includes a user ID block 3001, a password block 3002, and a domain information block 3003.

The screen 3000 may further include an e-mail information block 3004 to receive a notice upon completion of a job.

If a user enters an information value to correspond to each block and then presses an OK button, each information value is stored in the job queue as the screen is closed. If the user presses a cancel button, the job that has been established in the above scheme is deleted.

Alternatively, log-in information may not be required in performing a job, that is, the MCB part 200 may not require an authentication stage. In this case, the screen is configured to receive user information based on all cases that authentication is required or not required. To this end, the screen displays a notice indicating an anonymous log-in is available in case that a user has information in advance that the image forming apparatus does not require authentication or there is a job available for use without log-in information

Referring again to FIG. 8, the job information manager 1105c manages a job queue. If a job is generated through the job information page, the job information manager 1105c puts the generated job to the job queue and checks whether all information required is entered or an error exists. On a job status screen, a request may be made for a job included in the job queue, or a request may be made to delete the queued job.

The job priority manager 1105d may receive a priority order for jobs stored in the job queue. For example, when a print job is stored prior to a scan job in the job queue, and if information received through the device status manager 1105a represents that a scan job is currently available for use, the scan job is executed prior to the print job. Whether to execute jobs in such an automatic scheme or whether to execute a preceding job first may be determined at the setting of the job information page or the setting of the image forming apparatus.

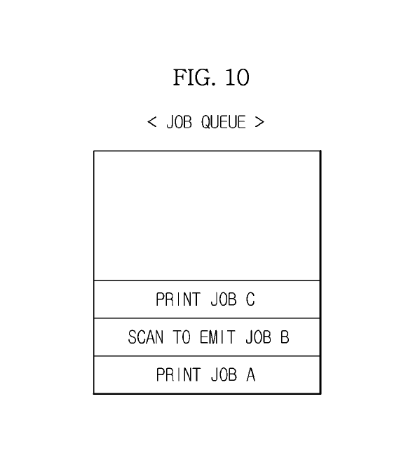

FIG. 10 is a view used to explain an operation of a priority order manager of a job queue manager of an OPE part that primarily performs a job, which is available in a MCB part, among a plurality of jobs stored in a job queue in an image forming apparatus according to an embodiment of the present disclosure.

Referring to FIG. 10, first, a print job A is input into the job queue and then a scan to email job B and a print job C are sequentially input into the job queue and the jobs A, B and C are stacked in the order that the jobs A, B and C are input. If the priority manager 1105b detects that a scan job is currently available for use by checking the priority manager 1105b, the scan to email job B may be performed prior to the print job A. In this manner, mutually exclusive jobs are performed in order of priority, thereby enhancing the efficiency in using resources.

In addition, the priority order for the jobs, which are stored in the job queue, may be input by a user through the job information page.

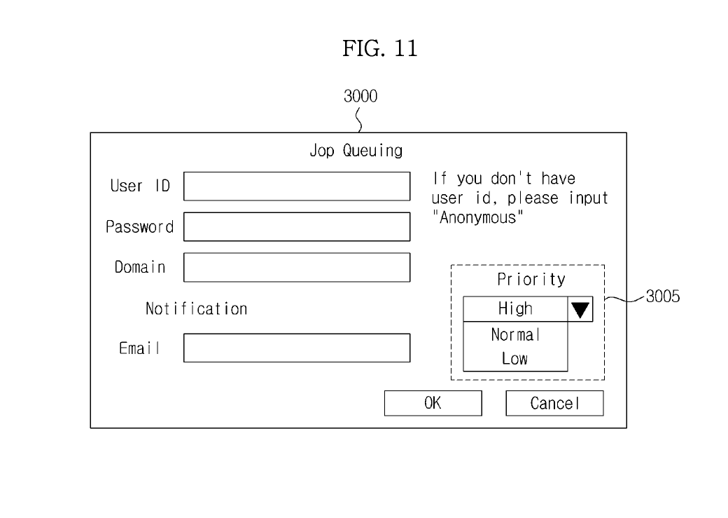

FIG. 11 is a view used to explain an operation of receiving a priority order of a job from a user through the screen shown in FIG. 9.

Referring to FIG. 11, the screen 3000 may include a priority setting block 3005 used to receive a priority order for a job from a user.

For example, the priority setting block 3005 is configured to set to “Low,” “Normal” and “High” such that the priority order of a job is selected by a user. The priority information selected by a user is valid only when the log-in stage is passed. Meanwhile, even if a job has a priority order of “High,” it is not that the job is always processed prior to other jobs, but the job is processed based on the type of a job available for execution in the MCB part 200.

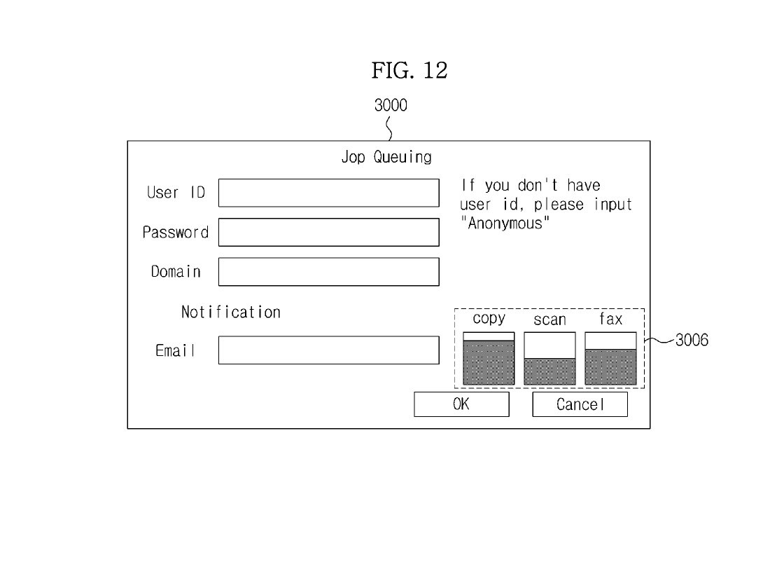

FIG. 12 is a view illustrating a booting progress of each device on a screen that is generated by a job information page generator of an OPE part in an image forming apparatus according to an embodiment of the present disclosure.

Referring to FIG. 12, the screen 3000 may include a device status display block 3006 that displays the degree of availability of each device for a normal operation, that is, a booting progress of each device in real time by checking a real-time status of each device of the MCB part. The device status display block 3006 may be provided in the form of a bar, which represents a progress for a normal operation of a photocopier, a scanner, and a facsimile, at the lower right portion of the screen 3000.

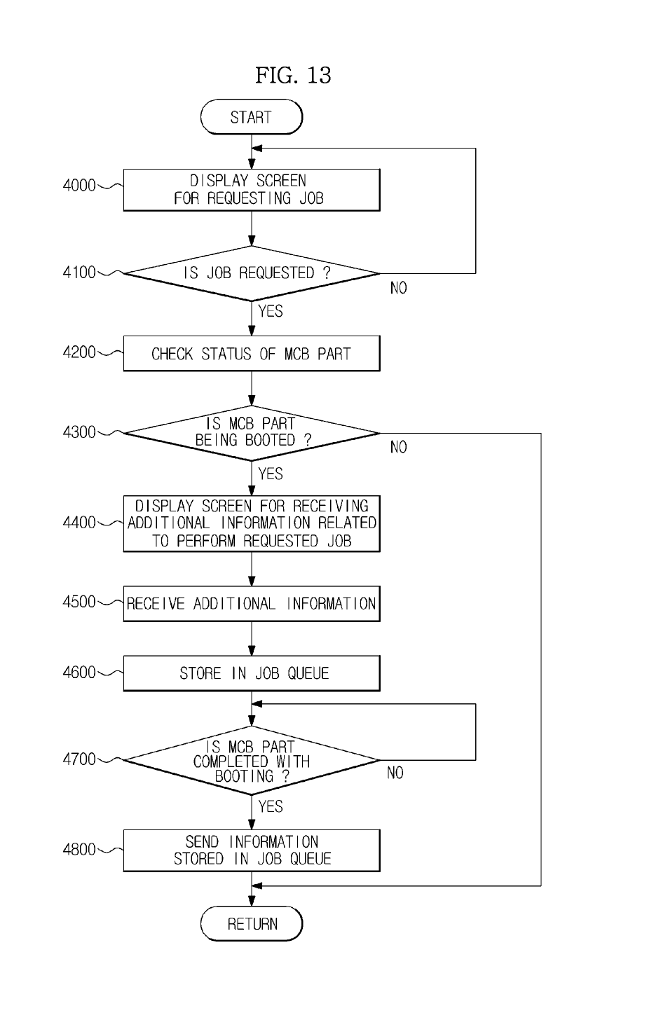

FIG. 13 is a flow chart illustrating a control method of an OPE part of an image forming apparatus according to an embodiment of the present disclosure.

Referring to FIG. 13, the OPE part 100 displays a screen used to receive a request for a job from a user (4000).

The OPE part 100 checks a user's input to determine whether a request for a job is made by a user based on the displayed screen (4100).

If a result of determination is that a request for a job is made by a user, the OPE part 100 checks the status of the MCB part 200 to determine whether the MCB part 200 is being booted by communicating with the MCB part 200 (4200).

By checking the status of the MCB part 200, the OPE part 100 determines whether the MCB part 200 is being booted (4300).

If a result of determination is that the MCB 200 is being booted in operation 4300, the OPE part 100 displays a screen used to receive additional information related to performing the job requested by the user (4400).

Additional information is input by the user through the screen displayed in operation 4400 (4500).

The OPE part 100 stores job information on the request job and the additional information input by the user in a job queue (4600).

Thereafter, the OPE part 100 determines whether the MCB part 200 is completed with booting (4700).

If the MCB part 200 is completed booting, the OPE part 100 sends the MCB part 200 the job information and the additional information stored in a job queue (4800). An operation mode returns to a predetermined routine. Accordingly, the MCB part 200 checks the job information and the additional information, which are received from the OPE part 100, and determines whether to perform the job based on the additional information, or to perform the job based on the additional information.

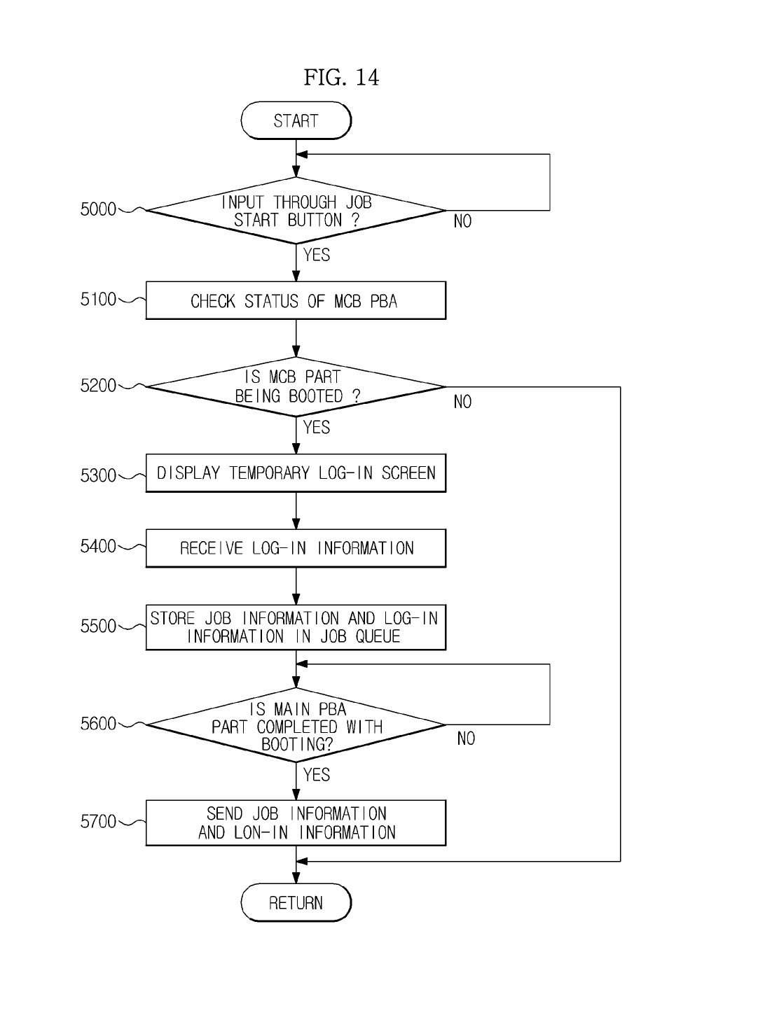

FIG. 14 is a flow chart used to explain an operation of an OPE PBA of an image forming apparatus according to an embodiment of the present disclosure, the OPE PBA receiving log-in information as additional information in advance while a main PBA is being booted

Referring to FIG. 14, the OPE PBA 101 of the OPE part 100 determines whether an input has been received through selection of a job start (5000).

If a result of determination is that the input through the job start button has been received, the OPE PBA 101 checks the status of the main PBA 201 of the MCB 200 (5100) to determine whether the main PBA 201 is being booted (5200).

If a result of determination in operation 5200 is that the main PBA 201 is being booted, the OPE PBA 101 displays a temporary log-in screen which is used to receive log-in information from a user in advance (5300). The temporary log-in screen is different from a normal log-in screen, which is provided to the OPE PBA when the main PBA 201 is completed with booting.

The OPE PBA 101 receives log-in information from a user (5400).

After the log-in information is input by the user, the OPE PBA 101 stores job information on a job, which is requested by the user, and log-in information, which is input by the user, in a job queue (5500).

If the main PBA 201 is completed with booting, the OPE PBA 101 sends the main PBA 201 the job information and the log-in information that are stored in the job queue (5700).

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An image forming apparatus having a main board configured to control an operation of the image forming apparatus, the image forming apparatus comprising:
an input unit configured to receive job information for requesting a job from a user;
a display unit configured to display a screen which is used to receive additional information, which is related to perform the job requested by the user;
a storage unit configured to store the job information and the additional information;
an interface unit configured to communicate with the main board; and
a control unit configured to determine whether the main board is being booted when a job is requested by a user, to control the display unit to display a screen, which is used to receive additional information related to performing the requested job in advance, when the main board is being booted, to store the job information and the additional information, which are received from the user as the screen is displayed, in the storage unit, and to transfer the job information and the additional information stored in the store unit to the main board when the main board is completed with booting.

2. The image forming apparatus of claim 1, wherein the additional information comprises log-in information.

3. The image forming apparatus of claim 2, wherein the additional information comprises email information which is used to receive a notice after the requested job is completed with processing.

4. The image forming apparatus of claim 1, wherein the control unit stores a plurality pieces of job information in the storage unit, and if a plurality of devices connected to the main board are sequentially completed with booting, transfers the plurality of job information in a transfer order that varies with an order that the plurality of devices are completed with booting.

5. The image forming apparatus of claim 1, wherein the control unit generates the screen such that the screen has a priority order setting block used to receive a priority order for the job requested by the user.

6. The image forming apparatus of claim 1, wherein the control unit generates the screen such that the screen has a device status block representing a real time booting progress of each device connected to the main board.

7. A method of controlling an image forming apparatus having a main board configured to control an operation of the image forming apparatus, the method comprising:
determining whether the main board is being booted if a job is requested by a user;
displaying a screen, which is used to receive additional information related to performing the requested job in advance, when the main board is being booted;
storing job information for requesting the job and the additional information, which are received from the user as the screen is displayed, in a job queue; and
transferring the job information and the additional information stored in the job queue to the main board when the main board is completed with booting.

8. The method of claim 7, wherein in the displaying of the screen, the additional information comprises log-in information.

9. The method of claim 8, wherein in the displaying of the screen, the additional information comprises email information used to receive a notice after the requested job is completed with processing.

10. The method of claim 7, wherein in the displaying of the screen, the screen comprises a priority order setting block used to receive a priority order for the requested job.

11. The method of claim 7, wherein in the displaying of the screen, the screen comprises a device status block representing a real time booting progress of each device connected to the main board.

12. An operational panel printed circuit board assembly communicating with a main board that is configured to control an operation of an image forming apparatus, the operational panel printed circuit board comprising:
an input unit configured to receive job information for requesting a job from a user;
a display unit configured to display a screen used to receive log-in information from the user;
a storage unit configured to store the job information and the log-in information;
an interface unit configured to communicate with the main board; and
a control unit configured to determine whether the main board is being booted when a job is requested by a user, to control the display unit to display a screen, which is used to receive log-in information from the user in advance, when the main board is being booted, to store the job information and the log-in information, which are received from the user as the screen is displayed, in the storage unit, and to transfer the job information and the log-in information stored in the store unit to the main board when the main board is completed with booting.

13. The operational panel printed circuit board assembly of claim 12, wherein the control unit generates the screen such that the screen has a priority order setting block used to receive a priority order for the requested job.

14. The operational panel printed circuit board assembly of claim 12, wherein the control unit generates the screen such that the screen has a device status block representing a real time booting progress of each device connected to the main board.

15. An image forming apparatus comprising
a main board configured to control an operation of the image forming apparatus, wherein the main board comprises;
a device status checker to check the status of each device connected to the image forming apparatus;
a communications unit configured to communicate and to send the check status to an operational panel printed circuit board assembly;
the operational panel printed circuit board assembly comprises;
an input unit configured to receive job information for requesting a job from a user;
a display unit configured to display a screen used to receive information from the user;
a storage unit configured to store the job information and the log-in information;
an interface unit configured to communicate with the main board;
a control unit configured to determine whether the main board is being booted when a job is requested by a user using the received status of the devices, to control the display unit to display a screen, which is used to receive information from the user in advance, when the main board is being booted, to store the job information and the information from the user, which are received from the user as the screen is displayed, in the storage unit, and to transfer the job information and the information from the user stored in the store unit to the main board when the main board is completed with booting.

16. An image forming apparatus of claim 15, wherein the operational panel printed circuit board further comprises: a job queue manager allowing the job requested by the user to be sent the main board to be carried out when the device connected to the main board to carry out the job request is booted when not all of the devices have finished being booted.
